(19) United States
(12) Patent Application Publication
(10) Pub. No.: US 2011/0018684 A1
(43) Pub. Date: Jan. 27, 2011

(54) REMOTE KEYLESS IGNITION SYSTEM AND METHOD

(76) Inventors: Wayne Hua Wang, Rochester Hills, MI (US); Aris Lambropoulos, Royal Oak, MI (US)

Correspondence Address: Continental Automotive Systems, Inc.;Patents & Licenses, 21440 W Lake Cook Road, Floor 7, Deer Park, IL, 60010, US

(21) Appl. No.: 12/508,222

(22) Filed: Jul. 23, 2009

(51) Int. Cl. G08B 29/00

(52) U.S. Cl. 340/5.62

(57) ABSTRACT

A keyless ignition module includes an actuator, antenna and control apparatus. The actuator has a front surface including a periphery extending therearound. The antenna is disposed rearward to at least some portion of the front surface and does not extend beyond the periphery of the front surface. The control apparatus includes a switch and is coupled to the antenna. The actuator being is slidably engagable with the switch such that movement of the actuator actuates the switch. The actuation of the switch causes the transmission of a control signal from the control apparatus to a vehicle controller.

### FIELD OF THE INVENTION

The field of the invention relates to remote keyless entry systems in vehicles and operating these systems.

### BACKGROUND

Over the years, various approaches have been used to start the engines of vehicles. In one example, a key may be turned to mechanically activate the ignition system of the vehicle. In another example, a keyless ignition system is used to start the engine of the vehicle. In this case, a user may possess a fob (or other similar device) that is needed to activate the ignition system. More specifically, the user places the fob or the device on or in the immediate vicinity of an ignition button. The fob transmits a secure signal that (when validated) enables the ignition system to be started when the user presses the ignition button.

However, a problem with these previous keyless ignition approaches has occurred when the fob runs out of power. For example, the fob may include a battery and over time the battery runs out of energy. This often happens at inconvenient times for the user such as at night or in the middle of the winter when extreme environmental conditions exist. In these situations, the user attempts to start their vehicle but since the fob has no energy, the vehicle can not be started. Consequently, the user can be inconvenienced and/or exposed to unsafe conditions.

One attempted solution for this problem is for the user to try to replace their fob or replace the battery in the fob. This is inconvenient to say the least because the user has to find a store or other establishment that has the correct replacement parts. This may be a difficult or dangerous undertaking at many times.

Other attempts have been made to solve these problems. For example, the fob may be somehow energized to transmit its security information and then the vehicle can be started. Unfortunately, these approaches utilized multiple parts that were complicated to assemble, were not compact, and could not be repaired or upgraded easily. For example, previous approaches relied upon an ignition module that used at least two antennas, one to transmit to the fob and a separate antenna to receive communications from the fob. These antennas were disposed at inconvenient locations that could not be easily accessed and/or replaced.

### BRIEF DESCRIPTION OF THE DRAWINGS

FIG. 1 comprises a block diagram of a keyless ignition system according to various embodiments of the present invention;

FIG. 2 comprises a flowchart of one example of an approach for operating a keyless ignition system according to various embodiments of the present invention;

FIG. 3 comprises a flowchart of another example of an approach for operating a keyless ignition system according to various embodiments of the present invention;

FIG. 4 comprises an exploded view of a keyless ignition system according to various embodiments of the present invention;

FIG. 5 comprises a perspective cut away of a keyless ignition system according to various embodiments of the present invention;

FIG. 6 comprises a side view of a keyless ignition system according to various embodiments of the present invention;

FIG. 7 comprises a perspective view of an assembled keyless ignition system according to various embodiments of the present invention;

FIG. 8 comprises perspective views of the antenna and bobbin of a keyless ignition system according to various embodiments of the present invention;

FIG. 9 comprises a side view of an arrangement where the antenna moves with the actuator according to various embodiments of the present invention;

FIG. 10 comprises a side view of an arrangement where the antenna is embedded in the actuator according to various embodiments of the present invention;

FIG. 11 comprises a front view of the assembly with the antenna disposed behind the actuator according to various embodiments of the present invention;

FIG. 12 comprises a front view of the assembly with the antenna disposed at least partially at the surface of the actuator according to various embodiments of the present invention;

FIG. 13 comprises a front view of the assembly with the antenna disposed at least partially at the surface of the actuator according to various embodiments of the present invention;

FIG. 14 comprises a perspective view of the PCB board and switch assembly according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Approaches are provided where a vehicle can be started when a user's fob (or other actuation device) is dead (i.e., without power). The approaches described herein allow a compact, one-piece assembly to be used. In other words, a separate antenna need not be attached elsewhere within a vehicle body. The approaches described herein also do not interfere with movement of actuators used within the system. One antenna is used (not two or more) to transmit and receive communications simplifying the design and reducing costs. Easy access is provided to the antenna in order to make a replacement or repair of this component simple and cost effective to accomplish.

In many of these embodiments, a keyless ignition module includes an actuator, an antenna and a control apparatus. The actuator has a front surface including a periphery extending therearound. The antenna is disposed rearward to at least some portion of the front surface and does not extend beyond the periphery of the front surface. The control apparatus includes a switch and is coupled to the antenna. The actuator is slidably engagable with the switch such that movement of the actuator actuates the switch. The actuation of the switch causes the transmission of a control signal from the control apparatus to a vehicle controller.

In some of these examples, upon receipt of the control signal, the vehicle controller selectively and responsively transmits an antenna actuation signal to the control apparatus. Upon receiving the antenna actuation signal, the control apparatus activates the antenna and the antenna transmits an activation signal to a portable actuation device that is positioned in close proximity to the front surface of the actuator or is in engagement with the front surface of the actuator. The antenna receives an identification signal from the portable actuation device. The control apparatus (or some other entity) determines whether the identification signal is valid and when the signal is determined to be valid, transmits an engine start signal to the vehicle controller to start the engine of the vehicle.

The portable actuation device can be any number of devices, for example, it may be a fob. The actuator may also be any number of devices such as a button or the like. Other examples of portable actuation devices and actuators are possible.

The antenna can be disposed in any number of positions relative to the actuator. In one example, the antenna is disposed so as to be stationary with respect to the actuator. In another example, the antenna is coupled to the actuator and is configured to move with the actuator. In still another example, the antenna is at least partially embedded within the actuator. Other examples of antenna placement are possible.

Thus, in a keyless ignition system a vehicle's engine can be started even though a user's fob (or other actuation device) is dead (i.e., without power). The approaches described herein allow a compact, one-piece assembly to be used, for example, including only a single antenna. Easy access is provided to the antenna and other components in order to make replacement or repair of these components simple and cost effective.

The following examples are described with respect to vehicular applications (e.g., starting the engine of a vehicle). However, it will be appreciated that these approaches are applicable to other environments and applications where it is desired that an action be accomplished even though the fob or other portable actuation device of a user is out of power.

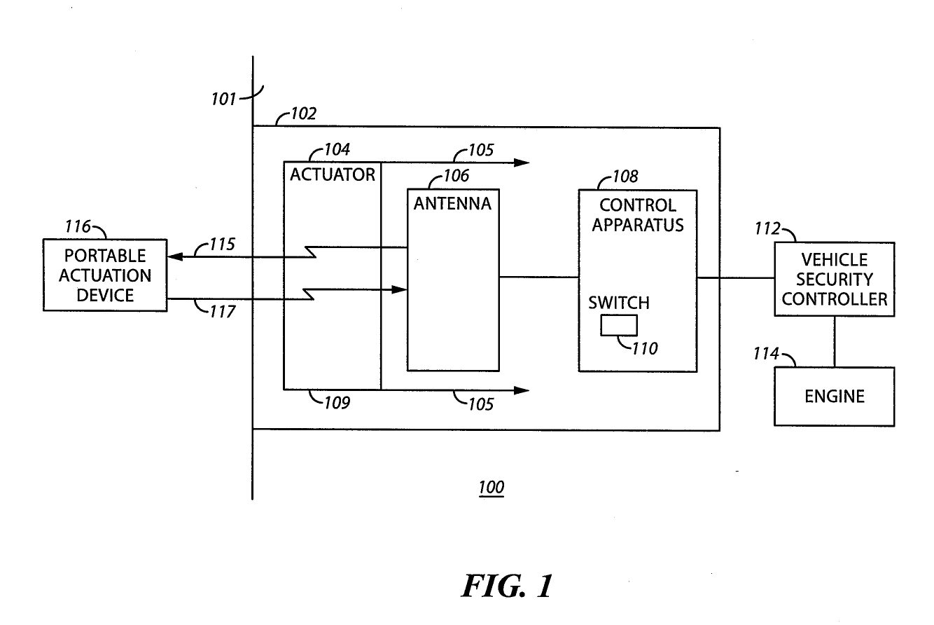

Referring now to FIG. 1, one example of an ignition module 100 that activates an engine 114 is described. A housing 102 includes an actuator 104, an antenna 106, and a control apparatus 108. The housing 102 (which may be constructed of any suitable material such as a plastic) is inserted into a body 101 of a vehicle (e.g., near the dashboard of the vehicle to name one example). In this respect, the body includes a receptacle or similar arrangement to receive the module 100.

The actuator 104 can be of any shape. For example, the actuator 104 may be a button or button-like device that is round, square, rectangular, and so forth. Other examples of actuators are possible. When pressed, the actuator 104 moves in a direction indicated by the arrows labeled 105.

The antenna 106 is any type of antenna that is configured to transmit and receive signals. In the present examples, the antenna 106 is an LF coil antenna. Other examples of antennas are possible. As shown in FIG. 1, the antenna 106 is disposed to the rear of the actuator 104 and does not extend beyond the periphery 109 of the actuator 104. As will be explained in greater detail herein, the antenna 106 may be fixed with respect to the movable actuator 104, move with the actuator 104, or be embedded at least partially within the actuator 104. The antenna 106 any type of arrangement configured to initiate communication and transmit signals to a portable device. The antenna can be any source that transmits any type of electromagnetic wave (of any type of frequency) or light to name two examples.

The control apparatus 108 may be a printed circuit board (PCB) with various digital and/or analog electronic components located thereupon. For example, the control apparatus 108 may include a programmed microprocessor or the like. The control apparatus 108 is coupled to the antenna 106 and includes a switch 110. The control apparatus 108 includes electrical connections that extend through the housing 102 to couple to a vehicle security controller 112 (which itself may communicate with an engine controller). When the actuator 104 is pressed inward, the switch 110 is mechanically actuated (i.e., moved) as the actuator 104 moves inward within the housing 102. As will be explained in greater detail herein, the actuation of the switch 110 causes a signal to be sent to the vehicle security controller 112. In some examples, an LED light (not shown in FIG. 1) from the control apparatus 108 is conducted by a light pipe (also not shown in FIG. 1) to the actuator 104. When the actuator 104 is pressed, the LED may be illuminated to illuminate the surface of the actuator 104.

A portable actuation device 116 is communicatively coupled to the antenna 106. The portable actuation device 116 can be a fob, but it can also be embedded in some other electrical device like a cell phone or the like. Other examples of portable actuation devices are possible.

In one example of the operation of the system of FIG. 1, a user opens the door of their vehicle mechanically with an emergency key and pushes their actuation device 116 (e.g., a fob on their keychain) against the actuator (e.g., button) 104. In this way, the user moves the actuator 104 inward into the housing 102. The inward movement of the button causes a switch 110 to be actuated on the control apparatus 108 (a PCB board). The actuation of the switch 110 sends a control signal to the vehicle or vehicle security controller 112.

The vehicle controller 112 receives the signal and then determines whether to issue a control signal to the control apparatus 108 to activate the antenna 106. The activation signal is sent by the vehicle controller 112 to the control apparatus 108 (within the housing 102) and relayed by the control apparatus 108 to the antenna 106. The antenna 106 in the housing 102 is responsively energized, and a signal 115 transmitted from the antenna 106. The portable actuation device 116 receives this signal 115. In one example, the antenna 106 transmits a challenge signal that forces the portable actuation device 116 to respond. The signal from the portable actuation device 116 includes a predetermined ID. If the ID matches an ID stored in the control apparatus 108 or vehicle security controller 112, the portable actuation device 116 is determined to be valid.

In many of these examples, the portable actuation device 116 itself includes a coil that is energized by the signal 115 from the antenna 106. As a result, the energized coil on the portable actuation device 116 transmits an identification signal 117 to the antenna 106. The identification signal 117 includes an identifier (e.g., a coded security identifier) that identifies the portable electronic device 116.

The same antenna 106 receives the information and this is relayed to the control apparatus 108. A determination is made either by the control apparatus 108 or the vehicle security controller 112 as to whether the signal 117 is valid. If a valid determination is made, the engine 114 is started.

As mentioned, the antenna may be disposed in various positions. In one example, the antenna 106 is stationary with respect to the actuator 104. In this example, when the actuator 104 is fully pressed inward, it does not touch the antenna 106. In one example, this minimum separation distance is 6 mm. In other words, the antenna 106 is disposed far enough ahead in the housing 102 to be within range to activate a fob but not too far ahead to interfere with the movement of the actuator 104 towards the control apparatus 108. In another example, the antenna 106 moves with the actuator 104. As discussed elsewhere herein, the antenna 106 may be coupled to another component such as a bobbin to name one example.

In still another example, the antenna 106 is at least partially embedded with the actuator 104 but does not extend beyond the periphery of the button. This positioning may achieve a decorative effect, for example, the antenna appears as a single metallic circle on the button surface and is constructed of material that allows pressing to occur (without damage to the antenna).

Consequently, a vehicle can be started when a user's fob (or other actuation device) is dead (i.e., without power). The approaches described herein allow a compact, one-piece assembly to be used. In other words, a separate antenna need not be attached within a vehicle body or elsewhere. The approaches described herein also do not interfere with movement of the actuation device. One antenna is used (not two or more) simplifying the design and reducing costs. Easy access is provided to the antenna in order to make a replacement or repair simple and cost effective to accomplish.

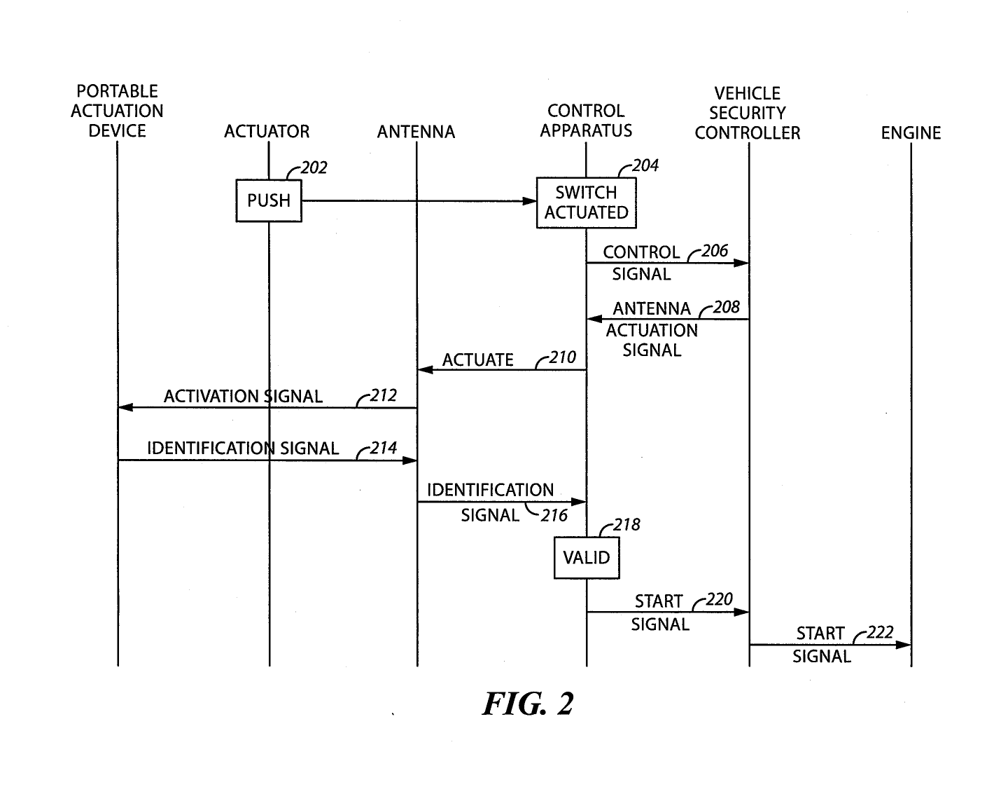

Referring now to FIG. 2, one example of operating an ignition system is described using a fob (or other portable actuation device) that is without power. At step 202, the actuator is pushed. For example, if the actuator is a button the user may use their fob to press the button inward.

At step 204, the inward movement of the actuator actuates a switch at the control apparatus (e.g., PCB). For example, a toggle switch may be thrown. At step 206, a control signal is sent from the control apparatus to an engine or vehicle controller. At step 208, the vehicle security controller determines whether to respond and, if an affirmative determination is made, responds with an antenna actuation signal. In some circumstances, validation of the portable actuation device (e.g., fob) occurs during vehicle door opening, before button pressing. In other words, the controller will not activate the antenna if a valid fob is already detected.

At step 210, the control apparatus sends an actuate signal to the antenna. At step 212, the antenna receives the signal, the antenna is responsively energized, and an activation signal is sent from the antenna to the portable electronic device. The portable electronic device is positioned so as to be in close proximity to the actuator. As such, the portable electronic device is either touching the actuator or is within the reception range of the antenna (e.g., within a few millimeters of the antenna).

The portable electronic device (having no internal power available) receives the activation signal 212 at a coil at the portable electronic device. The coil within the portable actuation device is energized and responsively transmits an identification signal 214 to the antenna. At step 216, the identification signal is sent from the antenna to the control apparatus.

At step 218, the control apparatus determines if the identification signal is from a valid device. For example, the control apparatus may compare the identifier in the identification signal with a set of stored and known valid identifiers to see if there is a match. If a match exists, then the identification signal is deemed to be valid. Alternatively, this determination may be made at the vehicle security controller. Other approaches may also be used to determine if the identifier is valid. If a valid determination is not made, an error or alter condition may be reported to the user or some security system.

If the identifications signal is valid, a start signal 220 is sent from the control apparatus or vehicle controller to the vehicle security controller. At step 222, the engine is started.

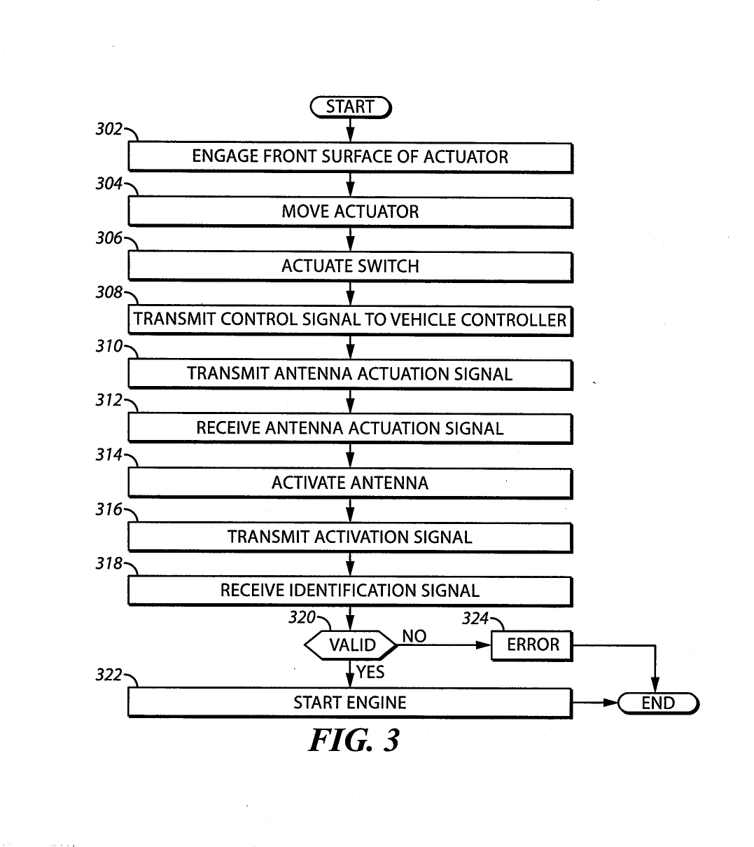

Referring now to FIG. 3, one example of an approach for operating a keyless ignition module when the fob is dead is described. At step 302, the front surface of an actuator is engaged with a portable actuation device, the front surface having a periphery extending therearound. At step 304, the actuator is moved by continually pressing the front surface with the portable actuation device. At step 306, a switch on a control apparatus is actuated as a result of the movement of the actuator. The antenna is disposed rearward to at least some portion of the front surface of the actuator and does not extend beyond the periphery of the front surface of the actuator.

At step 308, a control signal is transmitted to a vehicle controller upon actuating the switch. Upon receipt of the control signal at the vehicle controller, at step 310 an antenna actuation signal is selectively and responsively transmitted from the vehicle controller to the control apparatus. At step 312, the antenna actuation signal is received at the control apparatus. Upon receiving the antenna actuation signal, at step 314 the antenna is activated. At step 316, the activation signal is sent from the antenna to the portable actuation device.

At step 318, an identification signal is received from the portable actuation device at the antenna. At step 320, it is determined whether the identification signal is valid and at step 322 when valid, an engine start signal from the control apparatus to the vehicle controller to start an engine. Alternatively, if a valid condition is not determined, an error condition is determined at step 324.

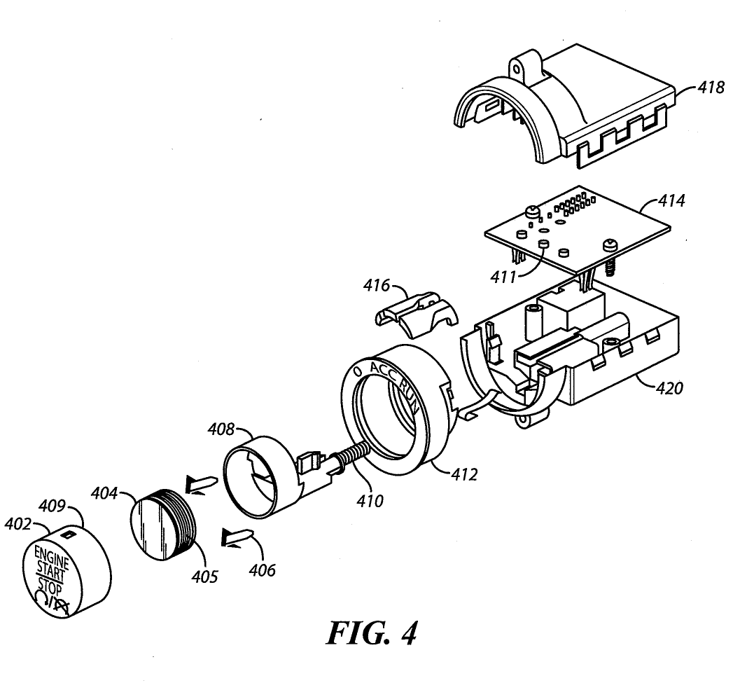

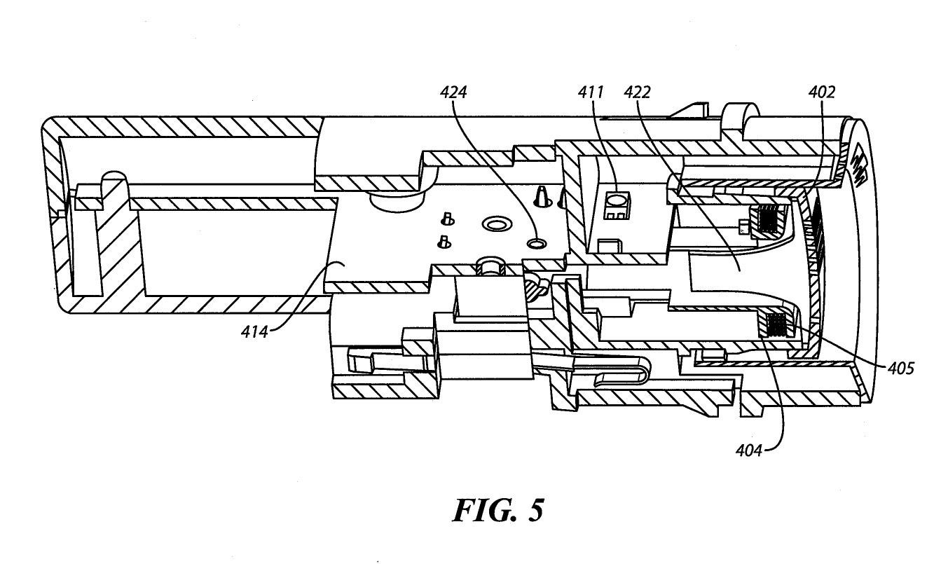

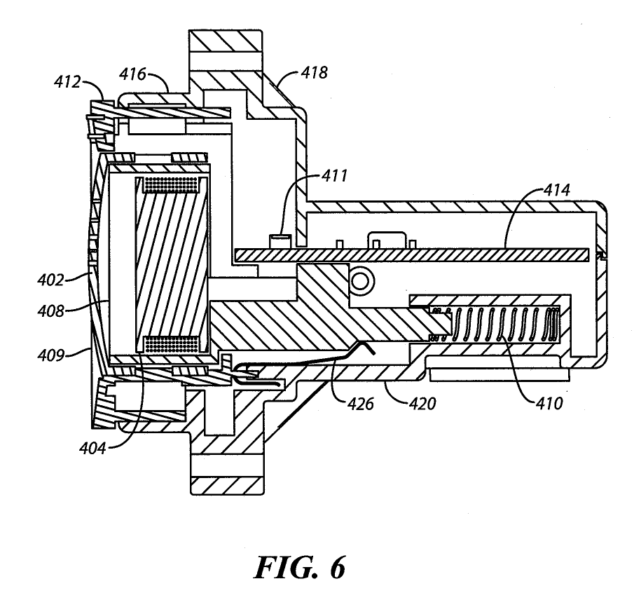

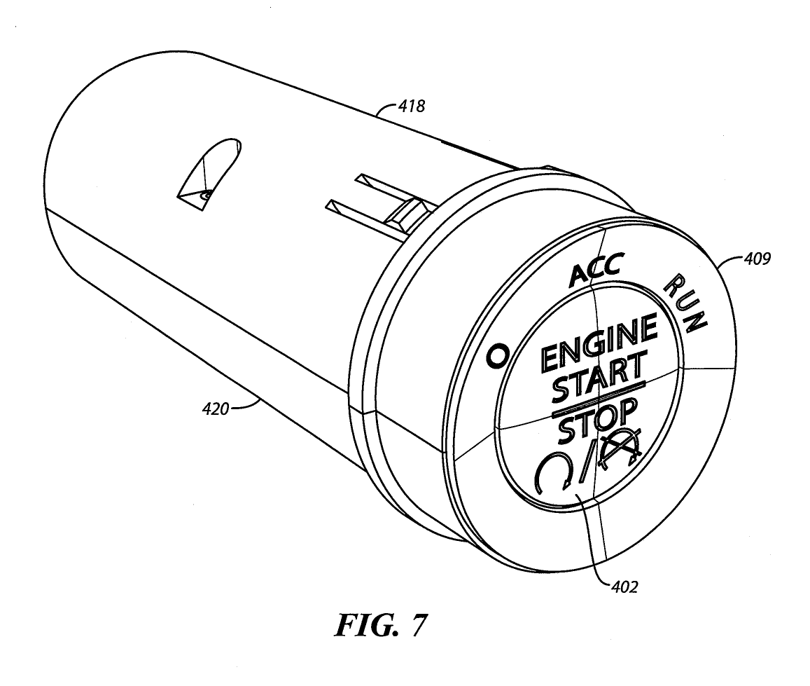

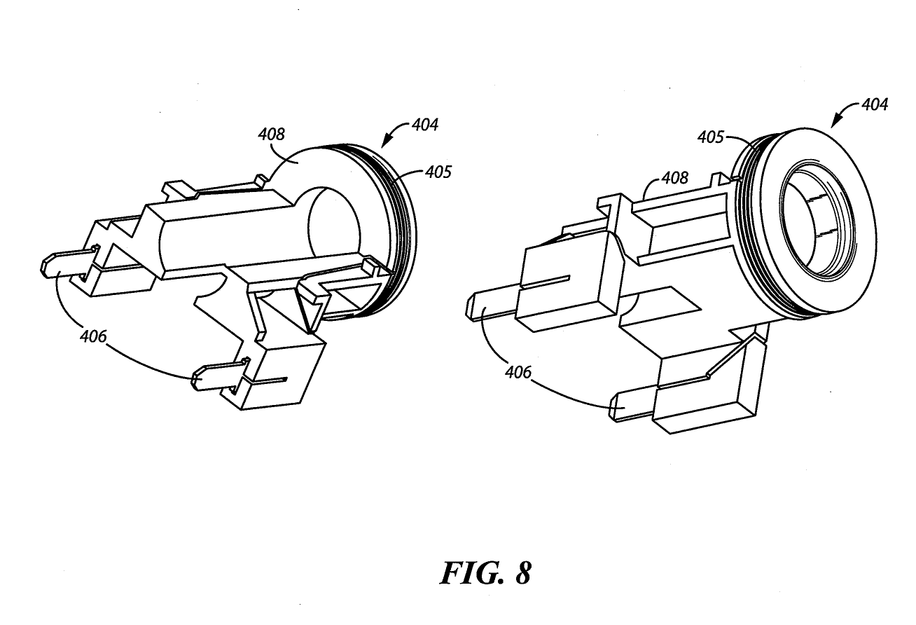

Referring now to FIGS. 4-8, and 14 one example of an ignition module 400 is described. An antenna assembly 404 (including a coil antenna 405 that is wound around a bobbin) is disposed rearward of an actuator 402 (e.g., behind the surface of the actuator towards the interior of the module 400). In one example, the actuator 402 is a button having a diameter of approximately 30 mm. The profile of the antenna assembly 404 (and specifically the antenna located thereupon) does not extend beyond the periphery 409 of the actuator 402.

The antenna assembly 404 is disposed within an actuator assembly 408. In one example, the antenna assembly 404 includes a circular LF coil 405 with approximately a 24 mm outer diameter and this is disposed on the bobbin. In one example, the antenna 405 on the antenna assembly 404 is located approximately 6 mm back from the actuator 402 when the actuator is in the fully depressed condition. Leads 406 of the antenna assembly 404 are connected to the control apparatus 414 and the antenna 405. The control apparatus 414 may be a PCB and include a microprocessor or the like. The control apparatus 414 may include a switch 411.

The bobbin of the antenna assembly 404 can be constructed of plastic or other suitable material. The antenna assembly 404 (including the antenna 405) is fixed with respect to the actuator 402. A decorative cover 412 surrounds the actuator 402. The decorative cover 412 may vary in color or construction according to the needs of the user or the system.

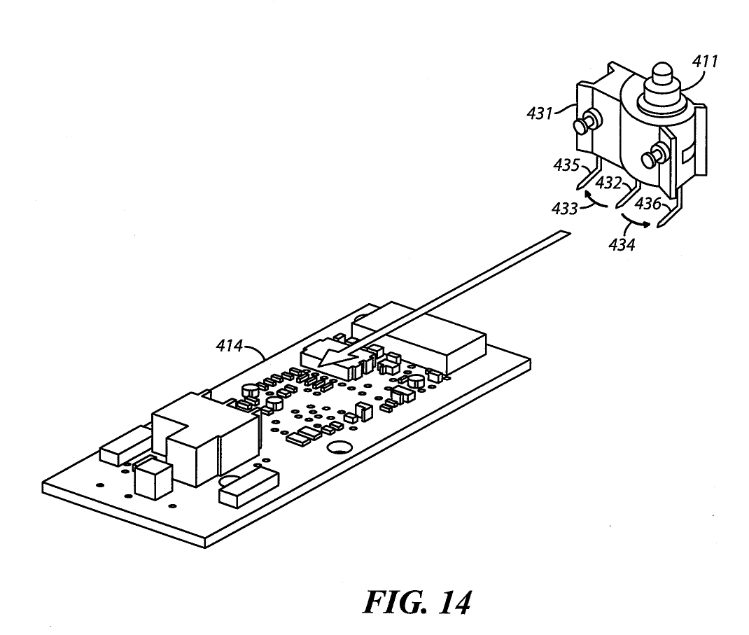

An actuator assembly 408 is disposed so as to surround the antenna assembly, is movable, and, in one example, is constructed of plastic or other suitable material. The actuator assembly 408 includes tabs 409. When the actuator 402 is pushed, that movement pushes the actuator assembly 408. The tabs 409 act to actuate the switch 411 on the circuit board 414 as the movement occurs. As can be seen especially in FIG. 14, the switch 411 is disposed on a switching element 431. As the switch 411 is actuated (e.g., pressed down vertically or moved horizontally), a switching pin 432 moves in a direction indicated by the arrows 433 and 434 making contact with the switching pins 435 and 436. Of the three pins of the switching apparatus 432, 435, and 436, the pins 435 and 436 are fixed and pin 432 has internal contacts that move it to connect to either of the other pins internally. One of pins 435 or 436 is normally a closed pin and the other is the normally open pin. The internal contact of the pins is made as the switch is actuated. When actuated, the normally closed pin becomes open and normally open pin becomes open. When the actuator is released, the pins return to their original status.

A first tension spring 410 supplies tension to maintain the position of the actuator assembly 408 by tending to push it back to its original position when the actuator is not pushed. A second tension spring 426 provides tension for a “clicking” sensation with movement of the actuator 402.

A first top housing portion 416, a second top housing portion 418, and a bottom housing portion 420 include the above-mentioned components. These housing portions may be constructed from plastic or any other suitable material. When assembled, the length of this module is approximately 94 mm. Other examples are possible.

As the actuator is pushed inward into the module 400, it actuates the switch 411. As explained elsewhere herein, actuation of the switch 411 causes the antenna 405 to be energized which in turn actuates a portable actuation device such as a fob. This allows identification information to be sent from the fob to the control apparatus 414. When this information is validated, the engine can be activated. In this way, a fob that is without power can be still used to start the engine.

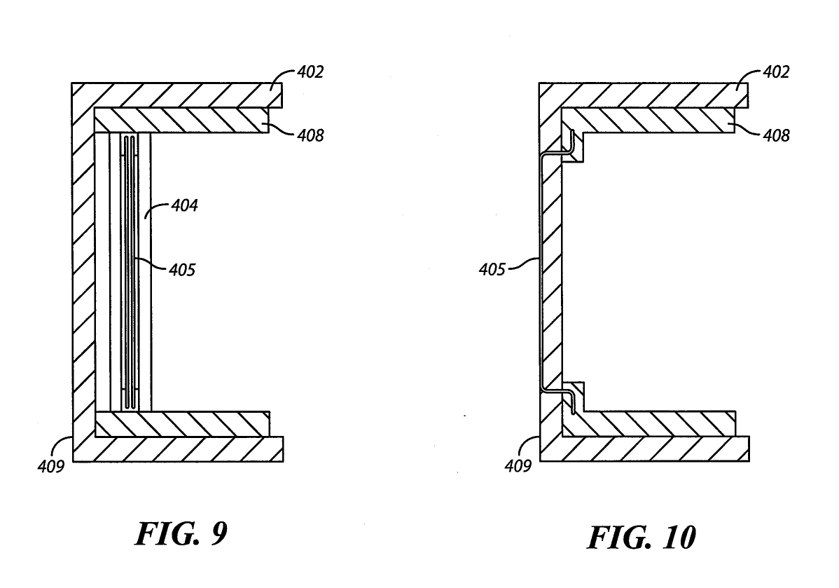

Referring now to FIG. 9, one example of an arrangement is described where the antenna travels with the actuator as the actuator moves. As shown in FIG. 9, the actuator 402 encloses the actuator assembly 408. The actuator assembly 408 holds the antenna assembly 404 (which includes a coil antenna 405 wound on the bobbin). The actuator assembly 408 may be attached to the antenna assembly 404 and the actuator 402 by any suitable approach such as gluing or with any type of fasteners or the like. As can be seen, pushing the actuator 402 moves the antenna assembly 404 and the actuator assembly 408 since the elements are attached together. In some approaches, the actuator assembly 408 can be omitted and the antenna assembly 404 directly connected to the actuator 402.

Referring now to FIG. 10, one example of an arrangement is described where the antenna 405 is embedded with the actuator. As shown in FIG. 10, the antenna 405 is embedded within the actuator 402 and extends through the actuator 402 to the actuator assembly 408. Thus, in this example, the antenna 405 extends to the surface of the actuator 402. As with the example of FIG. 9, pushing the actuator also moves the antenna 405.

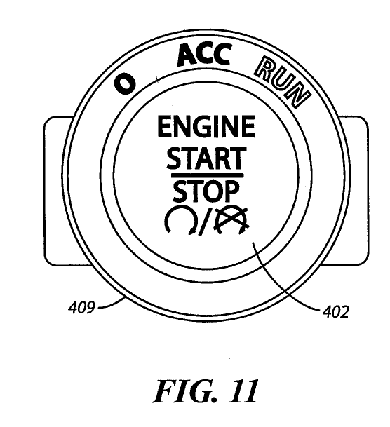

Referring now to FIG. 11, one example of the front face of the arrangement is described. In this example, the antenna assembly 404 is disposed completely behind the actuator 402 and can not be seen from the front when the unit is assembled.

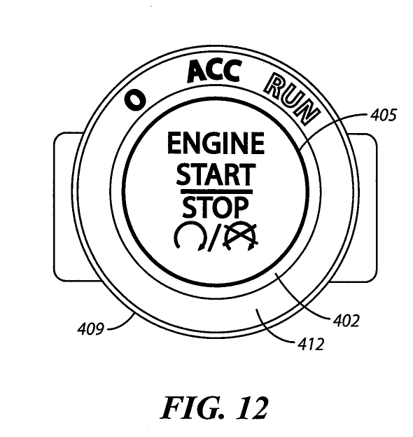

Referring now to FIG. 12, another example of the front face of the arrangement is described. In this example, the antenna 405 extends through the front surface of the actuator 402 and is circular in shape. The antenna 405 can be constructed of any suitable material to provide durability.

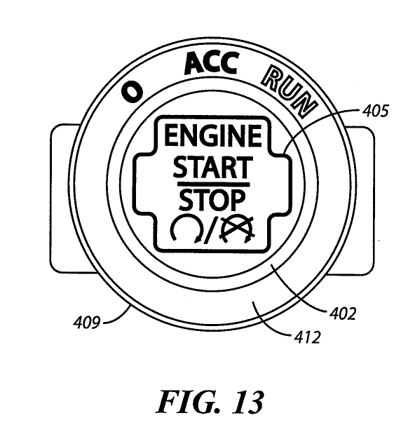

Referring now to FIG. 13, one example of the front face of the arrangement is described. In this example, the antenna 405 extends through the front surface of the actuator 402 and is non-circular in shape. It will be appreciated that the exact shape of the antenna at the surface of the actuator 402 can be adjusted according to aesthetic (or other) needs of the user or the system. The antenna 405 can be constructed of any suitable material such as a metal to provide durability.

Thus, approaches are provided where a vehicle can be started when a user's fob (or other actuation device) is dead (i.e., without power). The approaches described herein allow a compact, one-piece assembly to be used. In other words, a separate antenna need not be attached within a vehicle body. The approaches described herein also does not interfere with movement of the actuation device. One antenna is used (not two or more) simplifying the design and reducing costs. Easy access is provided to the antenna in order to make a replacement or repair simple and cost effective to accomplish.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A keyless ignition module, the module comprising:
an actuator, the actuator having a front surface including a periphery extending therearound;
an antenna disposed rearward to at least some portion of the front surface and not extending beyond the periphery of the front surface;
a control apparatus including a switch, the control apparatus being coupled to the antenna, the actuator being slidably engagable with the switch such that movement of the actuator actuates the switch, the actuation of the switch causing the transmission of a control signal from the control apparatus to a vehicle controller.

2. The module of claim 1,
wherein upon receipt of the control signal, the vehicle controller selectively and responsively transmits an antenna actuation signal to the control apparatus;
wherein upon receiving the antenna actuation signal, the control apparatus activates the antenna, the antenna transmitting an activation signal to a portable actuation device that is positioned in close proximity to the front surface or is in engagement with the front surface.

3. The module of claim 2, wherein the antenna receives an identification signal from the portable actuation device.

4. The module of claim 3, wherein the portable actuation device comprises a fob.

5. The module of claim 3, wherein the control apparatus determines whether the identification signal is valid and when the signal is valid, transmits an engine start signal to the vehicle controller to start an engine.

6. The module of claim 1, wherein the actuator comprises a button.

7. The module of claim 1, wherein the antenna is disposed so as to be stationary with respect to the actuator.

8. The module of claim 1, wherein the antenna is coupled to the actuator and is configured to move with the actuator.

9. The module of claim 1, wherein the antenna is at least partially embedded within the actuator.

10. A method of operating a keyless ignition module, the method comprising:
engaging a front surface of an actuator with a portable actuation device, the front surface having a periphery extending therearound;
moving the actuator by continually pressing the front surface with the portable actuation device;
actuating a switch on a control apparatus as a result of the moving, the antenna being disposed rearward to at least some portion of the front surface and not extending beyond the periphery of the front surface;
transmitting a control signal to a vehicle controller upon actuating the switch.

11. The method of claim 10, further comprising
upon receipt of the control signal at the vehicle controller, selectively and responsively transmitting an antenna actuation signal from the vehicle controller to the control apparatus;
receiving the antenna actuation signal at the control apparatus,
upon receiving the antenna actuation signal, activating the antenna;
transmitting an activation signal from the antenna to the portable actuation device.

12. The method of claim 11, further comprising receiving an identification signal from the portable actuation device at the antenna.

13. The method of claim 12, wherein the portable actuation device is a fob.

14. The method of claim 12, further comprising determining at the control apparatus whether the identification signal is valid and when valid transmitting an engine start signal from the control apparatus to the vehicle controller to start an engine.

15. The method of claim 10, wherein the actuator comprises a button.

16. The method of claim 10, wherein the antenna is disposed to be stationary with respect to the actuator.

17. The method of claim 10, wherein the antenna is coupled to the actuator and is disposed to move with the actuator.

18. The method of claim 10, wherein the antenna is at least partially embedded with the actuator.
